(19) United States
(12) Patent Application Publication
(10) Pub. No.: US 2017/0116184 A1
(43) Pub. Date: Apr. 27, 2017

(54) DYNAMIC USER INTERFACE LOCALE SWITCHING SYSTEM

(71) Applicant: International Business Machines Corporation, Armonk, NY (US)

(72) Inventors: Lisa M. Bradley, Cary, NC (US); Brian O'Donovan, Dublin (IE); Aaron J. Quirk, Cary, NC (US); Lin Sun, Cary, NC (US)

(21) Appl. No.: 14/919,985

(22) Filed: Oct. 22, 2015

(51) Int. Cl. G06F 17/28; G06F 17/27; G06F 3/0484

(52) U.S. Cl. CPC G06F 17/289; G06F 3/0484; G06F 17/2735

(57) ABSTRACT

An electronic device is configured to operate according to a plurality of different locales. The electronic device includes a display unit configured to display a graphical user interface, and at least one sensor configured to detect an input to the electronic device. The electronic device further includes an electronic computer processor in signal communication with the display unit and the at least one sensor. The computer processor is configured to identify an input language of the input, and based on the identified input language, dynamically transition the electronic device from a first locale among the plurality of locales into a second locale among the plurality of locales different from the first locale.

### BACKGROUND

The present invention relates to electronic devices, and more particularly, to a user interface (UI) displayed by an electronic device.

Electronic devices typically employ various graphical user interfaces (GUIs) to facilitate the operation of applications and programs to users in a “user friendly” manner. As compared to command line interfaces, which operate applications and programs in response to complex and convoluted commands and command syntax that must be memorized by the user, a GUI provides graphical objects such as windows, icons and various controls on the display screen that are manipulated by the user. These graphical objects are typically combined with word identifiers that allow the user to control the operation of the computer system in a more intuitively manner.

It is now common for electronic systems and devices to include multilingual GUIs. For example, various devices including, but not limited to, mobile devices, point of sale systems, banking systems, and so forth all have the ability for a user to operate the device according to one or more different locales or languages. Users of the device however, may find it challenging to configure the UI into the desired language. For example, a German tourist visiting Japan might not understand the Japanese language well enough determine how to switch the UI of a devices such as an electronic bank machine, for example, from its default Japanese language to the desired German language. Consequently, users may become frustrated and abandon the transaction without attempting to manipulate the UI graphics causing the business a loss of sale.

Similarly, consider the case on a mobile device where a multi-lingual user must manage different locales or languages on the device as the context and/or current applications change. For example, while at work the user may prefer the device to be operated according to an English locale but after hours the user may desire the device to operate according to a Chinese locale. In another example, when communicating with specific contacts during work hours the user would like to correspond in Chinese and would prefer the device to temporarily display applications with the Chinese locale, but switch back to an English locale when the correspondence is completed. The conventional process requiring users to constantly navigate to system configuration menus to manually switch between locales and languages can become tedious and inconvenient.

### SUMMARY

According to an embodiment of the present invention, an electronic device is configured to operate according to a plurality of different locales. The electronic device comprises a display unit configured to display a first user interface including first language data, and at least one sensor configured to detect speech. The electronic device further includes an electronic computer processor in signal communication with the display unit and the at least one sensor. The computer processor is configured to identify an input language of the speech, and based on the identified input language, convert the first language data into a second language matching the identified input language.

According to another embodiment, an electronic device is configured to operate according to a plurality of different locales. The electronic device includes a display unit configured to display a graphical user interface, and at least one sensor configured to detect an input to the electronic device. The electronic device further includes an electronic computer processor in signal communication with the display unit and the at least one sensor. The computer processor is configured to identify an input language of the input, and based on the identified input language, dynamically transition the electronic device from a first locale among the plurality of locales into a second locale among the plurality of locales different from the first locale.

According to yet another embodiment, a computer program product is configured to operate an electronic device according to a plurality of different locales. The computer program product comprises a computer readable storage medium having program instructions executable by an electronic computer processor such that the electronic device performs operations including displaying a first graphical user interface on a display of the electronic device, detecting an input to the electronic device, and identifying an input language of the input. Based on the identified input language, the electronic device dynamically transitions from a first locale among the plurality of locales into a second locale among the plurality of locales different from the first locale so as to change the first graphical user interface into a different second graphical user interface.

Additional features are realized through the techniques of the present invention. Other embodiments are described in detail herein and are considered a part of the claimed invention. For a better understanding of the invention with the features, refer to the description and to the drawings.

### BRIEF DESCRIPTION OF THE DRAWINGS

FIG. 1 is a block diagram illustrating a computing platform of an electronic device including a dynamic user interface locale switching system according to a non-limiting embodiment;

FIG. 2 is a block diagram illustrating the operation of a user interface locale switching system according to a non-limiting embodiment;

FIG. 3 is a schematic diagram illustrating a UI of a mobile electronic device undergoing a dynamic UI switching operation in response to various inputs;

FIG. 4 is a schematic diagram illustrating a UI of an electronic device undergoing a dynamic UI switching operation in response to detecting surrounding speech;

FIG. 5 is a flow diagram illustrating a method of dynamically switching a UI of an electronic device according to a non-limiting embodiment; and

FIG. 6 is a flow diagram illustrating a method of dynamically switching a UI of an electronic device according to another non-limiting embodiment.

### DETAILED DESCRIPTION

Various embodiments provide a device including a locale database that stores data corresponding to one or more country locales. That is, the data of each locale corresponds to a particular country or geographic region. The locale data includes, but is not limited to, language, numerals, currency, unit of measurements, time, holiday events, weather, etc. At least one embodiment is configured to detect a language spoken and/or written received by the device and automatically transition a first user interface of one or more applications running on the device to a second user interface corresponding to the detected language. Thus, the graphical user interface (i.e., UI) of the device can be dynamically transitioned into a different locale without requiring the user to manually manipulate a specific UI setting.

In at least one embodiment, the device monitors a locale of an active application and dynamically changes the current UI language of the device into a different language corresponding to the locale assigned to the active application. When the application is closed or deactivated, the device is capable of automatically transitioning the UI back into a default or desired locale without requiring the user to manually manipulate a specific UI setting. In this manner, the language and/or locale of the UI may be conveniently changed thereby improving the user's interaction with the device.

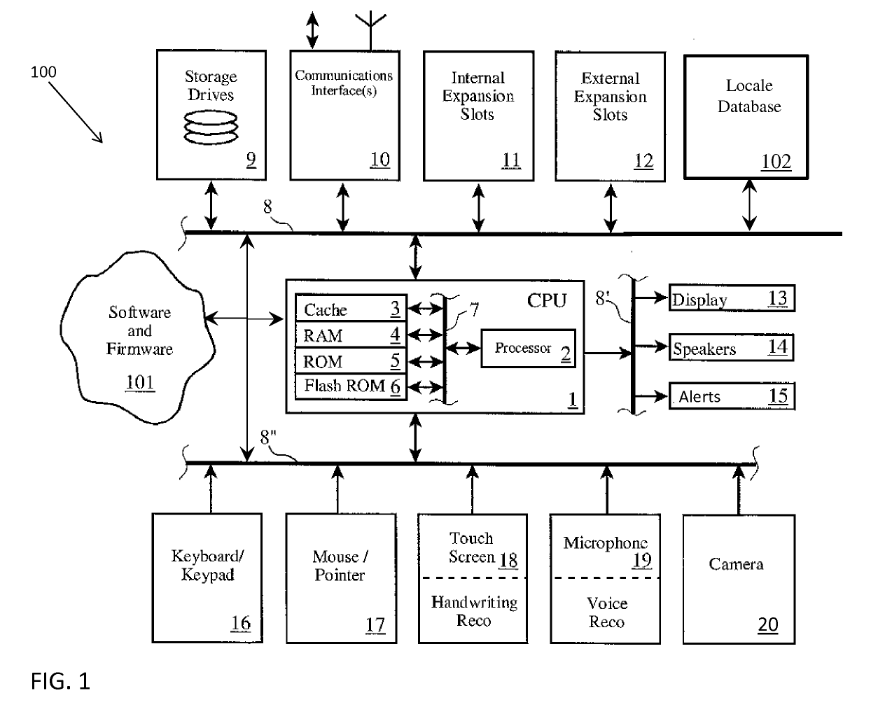

With reference now to FIG. 1, a computing platform of an electronic device 100 including a dynamic user interface locale switching system is illustrated according to a non-limiting embodiment. The device 100 includes a central processing unit 1 “CPU”, which is typically comprised of a hardware computer processor such as, for example, a microprocessor 2 associated with random access memory “RAM” 4 and read-only memory “ROM” 5. Often, the CPU 1 is also provided with cache memory 3 and programmable FlashROM 6. The interface 7 between the microprocessor 2 and the various types of CPU memory is often referred to as a “local bus”, but also may be a more generic or industry standard bus.

The device 100 further includes one or more storage drives 9, one or more communication interfaces 10, one or more internal expansion slots 11, and one or more external expansion slots 12. The storage drives 9 include, but are not limited to, hard-disk drives “HDD”, floppy disk drives, compact disc drives CD, CD-R, CD-RW, DVD, DVD-R, etc., and proprietary disk and tape drives e.g., lomega Zip™ and Jaz™, Addonics SuperDisk™, etc. Additionally, some storage drives may be accessible over a computer network. It should also be appreciated that the device 100 may electrically communicate with a cloud server (not shown) so as to enable and remotely execute various processes including, but not limited to, storage and delivery of audio data, audio processing, language recognition, locale data storage, and language dictionary storage.

The communication interfaces 10 are provided to facilitate one or more desired functions and operations of the computing platform. For example, a personal computer is often provided with a high speed serial port RS-232, RS-422, etc., an enhanced parallel port “EPP”, and one or more universal serial bus “USB” ports. The computing platform may also be provided with a local area network “LAN” interface, such as an Ethernet card, and other high-speed interfaces such as the High Performance Serial Bus IEEE-1394.

Computing platforms such as wireless telephones and wireless networked PDA's may also be provided with a radio frequency “RF” interface with antenna, as well. In some cases, the computing platform may be provided with an infrared data arrangement IrDA interface, or short-distance communication interface such as, for example Bluetooth™ interface.

The internal expansion slots 11 include, but are not limited to, Industry Standard Architecture ISA, Enhanced Industry Standard Architecture EISA, Peripheral Component Interconnect PCI, or proprietary interface slots for the addition of other hardware, such as sound cards, memory boards, and graphics accelerators.

The external expansion slots 12 allow the user to easily install and remove hardware expansion devices, such as, for example, PCMCIA cards, SmartMedia cards, and various proprietary modules such as removable hard drives, CD drives, and floppy drives. Often, the storage drives 9, communication interfaces 10, internal expansion slots 11 and external expansion slots 12 are interconnected with the CPU 1 via a standard or industry open bus architecture 8, such as ISA, EISA, or PCI. In many cases, the bus 8 may be of a proprietary design.

A computing platform is usually provided with one or more user input devices, such as a keyboard or a keypad 16, and mouse or pointer device 17, and/or a touch-screen display 18. In the case of a web-enabled wireless telephone, a simple keypad or virtual keyboard may be provided with one or more function-specific keys. In the case of a PDA, a touch-screen 18 is usually provided, often with handwriting recognition capabilities. When a virtual keyboard is implemented, the device 100 may be configured to dynamically change the characters displayed based on a current operating locale. For example, if the device 100 is operating according to an English locale, then the virtual keyboard displays English and Latin characters. When, however, the device is operating according to a Russian locale, the virtual keyboard displays Cyrillic characters.

Additionally, a microphone 19 and/or camera device 20 may be implemented to detecting various inputs and user biometrics. The microphone 19, such as a microphone of a web-enabled wireless telephone or the microphone of a personal computer, is configured to detect sounds in the surrounding area of the device 100. The sounds include, for example, input speech or voice commands of one or more persons located in the surrounding area. The microphone 19 may be used to input audio and/or voice signals, and or entering user choices, such as voice navigation of web sites or auto-dialing telephone numbers, using voice recognition capabilities. The camera device 20, such as a still digital camera or full motion video digital camera, is configured to detect motion or images. The device 100 may also include various types of image recognition software configured to detect the presence of the users captured by the camera device 20. In this manner, the device 100 is configured to perform real-time fascial and mouth recognition, extract one or more words based on the fascial and/or mouth recognition, and identify a spoken language based on the recognition operation.

One or more user output devices, such as a display unit 13, speakers 14 and/or alert devices 15, are also provided. The display 13 may take many forms, including a Cathode Ray Tube “CRT”, a Thin Flat Transistor “TFT” array, or a simple set of light emitting diodes “LED” or liquid crystal display “LCD” indicators. The speakers 14 may be used to reproduce audio and music, such as the speaker of a wireless telephone or the speakers of a personal computer. The alert devices 15 may take the form of sound emitters, buzzers, light emitters and/or vibration devices. These user input and output devices may be directly interconnected to the CPU 1 via a proprietary bus structure and/or interfaces, or they may be interconnected through one or more industry open buses such as ISA, EISA, PCI, etc.

The device 100 also includes one or more software programs, firmware programs and/or application programs (i.e., Apps), and a locale database 102. The software, firmware and/or Apps 101 implement a desired functionality of various computing platforms and applications (i.e., Apps). The software, firmware and/or Apps 101 are also configured to generate and display one or more graphical user interface (i.e., UIs) to facilitate execution of the Apps. According to a non-limiting embodiment, the processor or CPU 1 can detect detects the startup and launch of one or more software programs, firmware programs and/or Apps.

The locale database 102 is a database storing locale data corresponding to one or more country or geographic region locales. The locale data includes, but is not limited to, language dictionaries, numerals, currency, unit of measurements, time, holiday events, weather, etc. The software and firmware 101 may access the locale database 102 to retrieve language dictionaries and other locale data necessary to generate and display a UI corresponding to a particular locale. For example, a UI can be generated and displayed according to a language corresponding to particular locale.

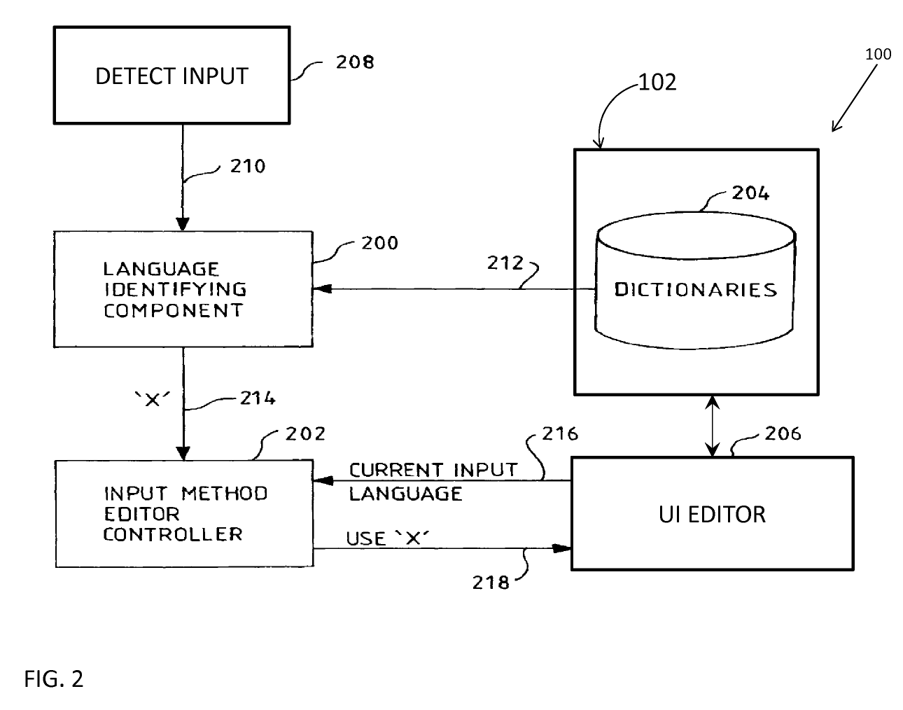

Turning now to FIG. 2, operation of a user interface locale switching system included with an electronic device 100 is illustrated according to a non-limiting embodiment. During operation, the device 100 detects one or more input 208. The inputs 102 may include, but are not limited to, detected sound, speech, and image capture. The input 102 may also include one or more launched or activated applications (Apps) such as a messaging application, calendar application, etc., detected by the processor or CPU 1. The device 100 may launch an App automatically (i.e., upon startup) and/or manually in response to input from a user. When an App is launched, the device 100 will detect (via a configuration settings file or similar) any locales stored in the locale database 102 and selected to correspond to the App. The device 100 also determines whether any language dictionaries 204 are assigned to the launched App. In this manner, the device 100 may launch the App and generate an initial UI based on an initial language dictionary 204 retrieved from the locale database 102. According to a non-limiting embodiment, language settings for a UI of a particular App are automatically changed according to the identified language of the detected input 208.

When an input 208 is detected, the input 208 is delivered to a language identification module 200 to be analyzed. The language identification module 200 may include. The analysis may include, for example, identifying a launched App, detecting sound as speech, identifying the language of the detected speech, determining a sender or recipient of a text message or email message, and parsing an incoming text or email. The message parsing may include parsing one or more characters of the received text message or email message, and analyzing the locale database 102 to determine if one or more language dictionaries 204 correspond to the detected language of the speech or parsed message.

Various techniques may be performed to facilitate the automatic identification of the detected language. According to a non-limiting embodiment, a word-based language identification and/or an N-gram-based identification may be implemented. The word-based language identification technique, for example, is based on the notion that the majority of languages have a set of commonly occurring words. For instance, a sentence containing the words ‘and’, ‘the’, ‘in’, would most probably be English, whereas a sentence with the word ‘der’ would be more likely to be German. In an implementation of this technique, the language dictionaries 204 comprise a separate lexicon for each possible language, and each word in the sample text is looked up to see in which lexicon it falls. The lexicon that contains the most words from the sample indicates which language was used. Weighted sum can be used, if words are provided with a score.

The character N-grams technique is based on a sequence of N consecutive characters, where N ranges typically from 2 to 5. Similarly to the common words technique, this technique assembles a language model from a corpus of documents in a particular language; the difference being that the model consists of character N-grams instead of complete words.

When the language identification module 200 identifies the language corresponding to the input (e.g., the detected speech, text message, email message, etc.), the language identification module 200 outputs an ID signal 214 indicating the identified language, (e.g., English, German, Chinese, etc.) to the controller 202. The controller 202 communicates with a UI editor 206 and requests the current locale or language of the device 100. If the language of the detected input 208 is different from the current language of the current UI, the controller 202 commands the UI editor to switch the locale of the entire device 100 or the language of current UI to the detected language of the detected input 208. In an embodiment, the controller 202 may already be aware of the current locale of the device 100 or the current language of the current UI, in which case a query signal 216 is not required. The controller 202 may also carry out checks to see that the language identified is one supported by the UI editor 206 or by the default system settings of the device 100.

In response to the command to change the UI, the UI editor 206 retrieves language ‘X’ from the language dictionary 204. Based on the retrieved language “X”, the UI editor 206 generates a new UI and outputs the new UI to the controller 202. The control 202 then displays the new UI based on the detected language (i.e., the retrieved language “X”), thereby allowing a user to interact with a changed UI corresponding to the detected input 208. Accordingly, the user is not required to manually adjust the language settings of the data processing system or device 100.

According to a non-limiting embodiment, each App may have a corresponding UI with its own assigned locale or language. In other words, each App UI may have its own locale and/or language setting such that different windows can have different UI settings at a particular time. In addition, the controller 202 may automatically change revert to the default locale or language when the user exits or deactivates the App associated with the detected input 208 and/or begins interacting with another App installed on the device 100.

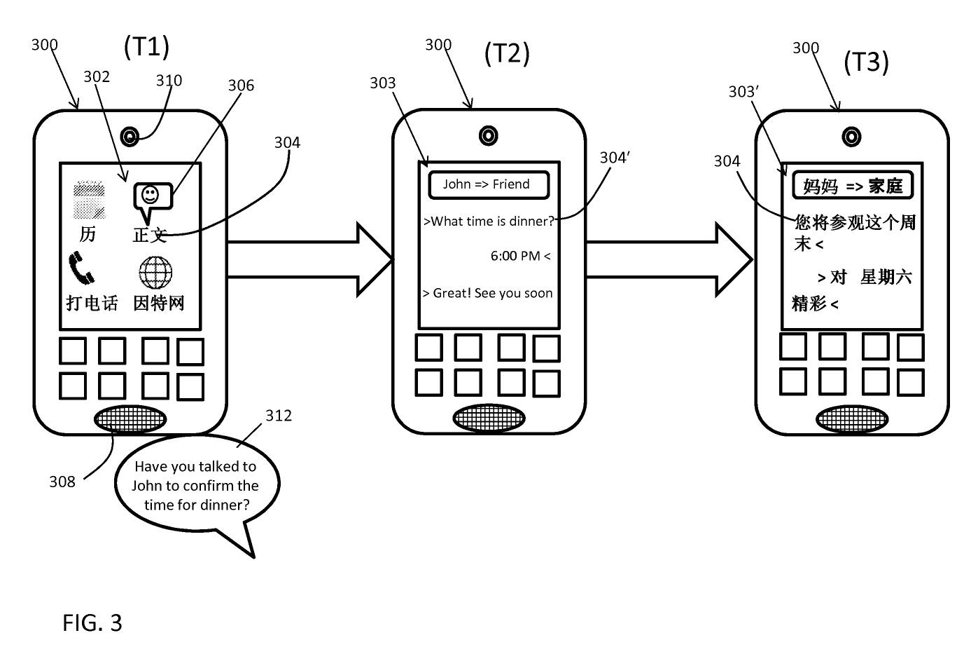

FIG. 3 illustrates a mobile electronic device 300 including a UI 302 capable of being dynamically displayed according to various detected inputs. At a first time period (T1), the device 300 operates according to a first locale. In this example, the first locale includes a Chinese locale. Accordingly, a first UI 302 is displayed according to the Chinese locale, and thus utilizes Chinese language characters 304 to identify corresponding graphical icons 306. During the first time period (T1), the device detects an input 312 using, for example, a microphone 308 and/or camera 310. In this example, the input is spoken language 312 detected by the microphone 308. In at least one embodiment, the device 300 can distinguish between background voices (e.g., noise) and the voice of a user associated with the device 300.

In response to the detected speech 312, the device 300 identifies the spoken language as English language, and retrieves an English language dictionary from the dictionary database. According to a non-limiting embodiment, the device 300 further recognizes the context of the detected spoken language. In this case, for example, the device 300 identifies the name “John” as a personal contact of the user of the device 300. For instance, the device 300 may extract the name from the detected speech and compare the name to one or more contact names stored in a contact database. When a contact is matched, the device 300 further determines if the matching contact is assigned a particular language. In at least one embodiment, a user may assign different locales and/or languages to contacts or contact groups included in the contact database. For example, a first group of contacts organized into a first contact group (e.g., friends) may be assigned a first locale and/or language (e.g., English in this example), while a second group of contacts organized into a second contact group (e.g., family) may be assigned a different locale and/or language (e.g., Chinese in this example).

In this example, the device 300 determines the extracted name “John” belongs to the “Friends” contact group, which is assigned to an English language UI. At time T2, the device 300 automatically launches a text message UI 303 that is displayed according to an English locale and/or English language. That is, the device 300 dynamically determines the English language of the detected speech at T1, and automatically transitions the device 300 from the first Chinese UI 302 to an English text message UI 303 to facilitate interaction with the device 300 in the English language. Generating the English UI 303 includes, but is not limited to, changing the letters of a virtual keyboard into English characters 304′, providing the user with English dictionary auto-corrections and suggested words, and displaying reply text in the English language.

According to at least one embodiment, a computer processor (not shown in FIG. 3) included in the device 300 generates a control signal that controls the electronic device 300 to generate an alert indicating the current locale has been transitioned into a different locale. For instance, the computer processor may activate a vibration device (not shown in FIG. 3) installed on the device 300 in response to transitioning the device 300 from the Chinese locale into the English locale. In this manner, the user of the device 300 is notified that the locale of the device 300 has been changed. It should be appreciated that other alerts may be activated in response to changing the locale of the device 300 including, but not limited to, outputting a sound, emitting a light, and/or displaying a graphical alert.

At time T3, the device 300 receives a text message from another contact assigned to a different locale or language. For example, the user of the device 300 receives a text message from a person belonging to a “Family” contact group, which is assigned a Chinese language UI. Accordingly, the device 300 dynamically determines the Chinese language assigned to the contact sending the text message, and automatically transitions the device 300 from the English text message UI to a Chinese text message UI 303′ to facilitate interaction with the device in the Chinese language. Accordingly, the user can automatically begin conversing with the sender in the transitioned language (e.g., Chinese). In a similar manner discussed above, the device 300 can initiate alert in response to reverting back into the Chinese locale.

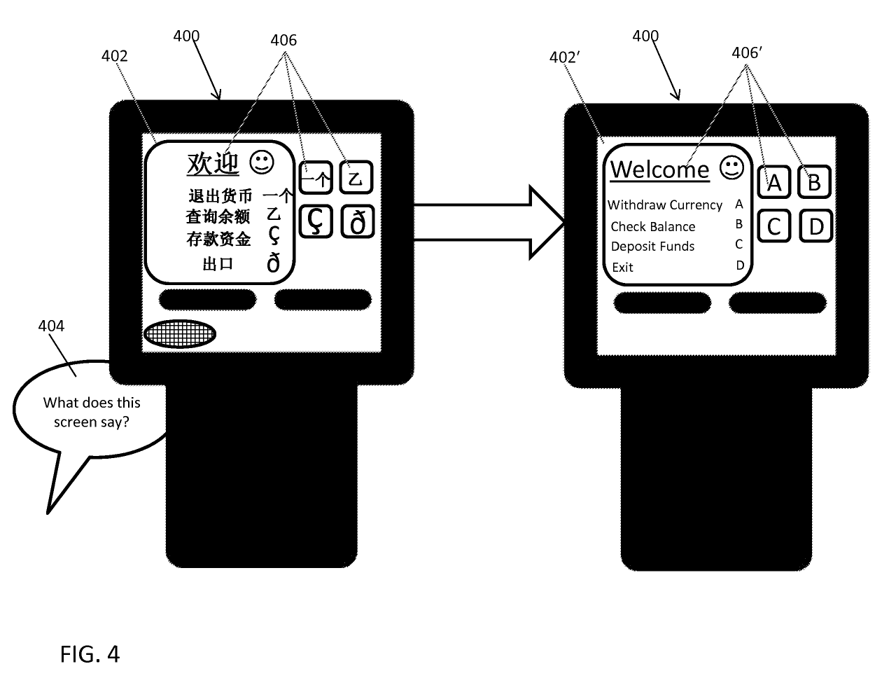

Turning now to FIG. 4, an electronic device 400 configured to dynamically switch a UI 402 in response to detecting an input 404 is illustrated according to a non-limiting embodiment. In this example, the electronic device 400 initially operates according to a first locale such as, for example, a Chinese locale. Accordingly, the electronic device 400 displays an initial UI 402 based on locale data 406 including, but not limited to, Chinese language, Chinese characters, and Chinese monetary units.

While operating in the first locale, the electronic device 400 detects an input 404 such as, for example, spoken language 404. As discussed in detail above, the device 400 is configured to identify the language of the detected input 404, and convert the current locale of the UI 402 to match the identified language of the detected input 404. In this case, for example, the device 400 identifies the detected spoken language as English. In turn, the device 400 retrieves English locale data 406′ from the locale database and converts the Chinese UI 402 into an English UI 402′. Accordingly, the user that initially provided the input 404 (i.e., the English speech) is automatically presented with an English-based UI 402′ which allows the user to conveniently operate the device 400 according their first or fluent language. Therefore, loss of business may be avoided. In at least one embodiment, once the user has completed using the converted UI 402′, the device 400 can automatically revert back to the initial UI 402 corresponding to the initial locale (in this case the Chinese locale).

As described above, at least one non-limiting embodiment provides a computer processor (not shown in FIG. 4) included in the 400, which is configured to output a control signal that initiates an alert indicating the current locale has been transitioned into a different locale. For instance, the computer processor of the device 400 may output a sound alert and/or graphical alert in response transitioning the locale. In this manner, a user of the device 400 is further notified that the locale of the device 400 has been changed. It should be appreciated that the method illustrated in the flow diagram of FIG. 4 may be implemented in a computer program product to operate an electronic device according to a plurality of different locales. The computer program product comprises a computer readable storage medium having program instructions embodied therewith, the program instructions executable by an electronic computer process such that the electronic device performs one or more various operations described in the instant description, including the operations described with respect to FIG. 4.

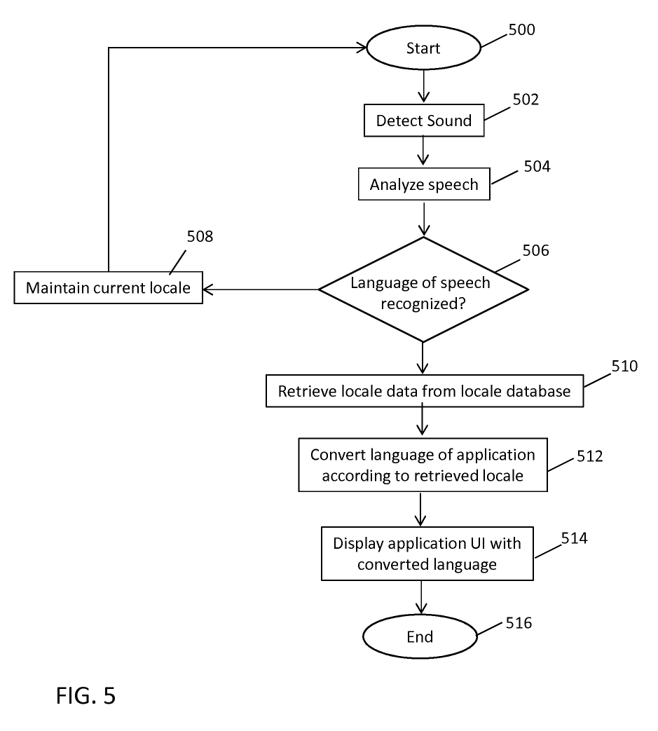

Turning now to FIG. 5, a flow diagram illustrates a method of dynamically switching a UI of an electronic device according to a non-limiting embodiment. The method begins at operation 500, and at operation 502, an input such as, for example, a sound is detected. At operation 504, the sound is identified as human speech and the speech is analyzed. At operation 506, a determination is made as to whether the language of the speech is recognized. When the language is not recognize, the current locale of the device is maintained at operation 508, and the method returns to operation 500 so as to detect a new input.

When, however, the language of the analyzed speech is recognized at operation 506, locale data corresponding to the identified language is retrieved from the locale data base at operation 510. The locale data may include, but is not limited to, language dictionaries, language characters, numerals, currency, unit of measurements, time, holiday events, weather, etc. At operation 512, the language of the application UI is converted based on the retrieved locale data. The converted application UI is displayed at operation 514 and the method ends at operation 516. Although the method is illustrated as ending after the converted UI is displayed, it should be appreciated that the method may also include automatically reverting one or more UIs of the device back to the initial locale after the user completes using the converted UI. In this manner, a method may be provided to dynamically transition one or more UIs of the device to anticipate the desired locale of the user at various instances or in response to various detected inputs such as, for example, detected speech. It should be appreciated that the method illustrated in the flow diagram of FIG. 5 may be implemented in a computer program product to operate an electronic device according to a plurality of different locales. The computer program product comprises a computer readable storage medium having program instructions embodied therewith, the program instructions executable by an electronic computer process such that the electronic device performs one or more various operations described in the instant description, including the operations described with respect to FIG. 5.

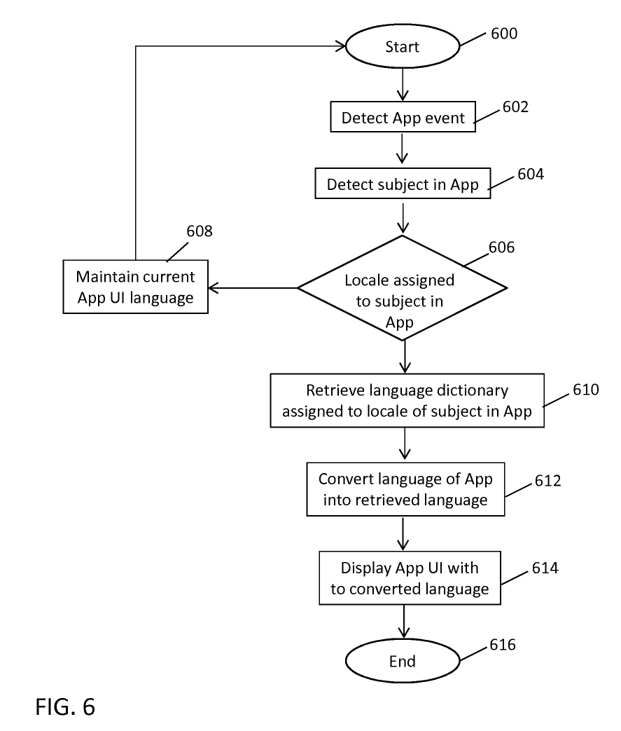

Turning now to FIG. 6, a flow diagram illustrates a method of dynamically switching a UI of an electronic device according to another non-limiting embodiment. The method begins at operation 600, and at operation 602 an application (App) event is detected. The App event may include, for example, an incoming text message, an incoming email, launch of a text message application, launch of email application, etc. At operation 604, a subject of the detected App event is identified. The subject may include, for example, a text sender, an intended text recipient, an email sender, an intended email recipient, etc. At operation 606, a determination is made as to whether a particular locale is assigned to the identified subject. For example, a first locale and/or language may be assigned to a first subject (e.g., a family member), while a different locale and/or language may be assigned to a second subject (e.g., a friend or co-worker). When a particular locale and/or language is not assigned to the identified subject, the current locale and/or language of the device is maintained at operation 608, and the method returns to operation 600 so as to detect a new input.

When, however, a particular locale and/or language is assigned to the identified subject at operation 606, locale data corresponding to the identified subject is retrieved from the locale data base at operation 610. The locale data may include, but is not limited to, language dictionaries, language characters, numerals, currency, unit of measurements, time, holiday events, weather, etc. At operation 612, the language of the application UI is converted based on the retrieved locale data. The converted application UI is displayed at operation 614, and the method ends at operation 616. Although the method is illustrated as ending after the converted UI is displayed, it should be appreciated that the method may also include automatically reverting one or more UIs of the device back to the initial locale after the user completes using the converted UI. In this manner, a method may be provided to dynamically transition one or more UIs of the device to anticipate the desired locale of the user at various instances or in response to various detected inputs such as, for example, a detected App event.

Accordingly, various embodiments of the invention provide an electronic device configured to identify an input such as, for example, spoken language, written language, and/or an App launch so as to automatically convert the current locale of the device into a different locale desired by the user. This identification is accomplished by monitoring various inputs including, for example, the device's physical environment, incoming and outgoing text base communications and/or incoming and outgoing email communications to determine language trends. With this information, the invention dynamically changes the locale of the device to match the identified language. Unlike conventional devices, a user is not required to access device setting menus and manually select a desired locale or language. In this manner, the language and/or locale of the UI may be conveniently changed thereby improving the user's interaction with the device.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. As used herein, the term “module” refers to an application specific integrated circuit (ASIC), an electronic circuit, an electronic computer processor (shared, dedicated, or group), a microprocessor and memory that executes one or more software or firmware programs, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An electronic device configured to operate according to a plurality of different locales, the electronic device comprising:
a display unit configured to display a graphical user interface;
at least one sensor configured to detect an input to the electronic device; and
an electronic computer processor in signal communication with the display unit and the at least one sensor, the computer processor configured to identify an input language of the input, and based on the identified input language, transitions the electronic device from a first locale among the plurality of locales into a second locale among the plurality of locales different from the first locale, the graphical user interface changed according to the second locale.

2. The electronic device of claim 1, wherein the first locale includes first language data and the second locale includes second language data different from the first language data.

3. The electronic device of claim 2, wherein transitioning the electronic device from the first locale into the second locale includes converting a first graphical user interface generated according to the first language data into a second graphical user interface generated according to the second language data different from the first language data.

4. The electronic device of claim 3, wherein the computer processor automatically transitions the second user interface back into the first user interface that displays the first language data after use of the second graphical user interface is completed without input from a user of the device.

5. The electronic device of claim 3, wherein the input includes at least one of spoken language, an incoming text message, an incoming email, a captured image, and activation of a software application.

6. The electronic device of claim 3, wherein the identification of the input language comprises:
extracting at least one word from the input;
comparing the at least one extracted word to a defined word included in at least one language dictionary; and
determining the input language corresponds to the first language dictionary in response to the extracted word matching the defined word.

7. The electronic device of claim 6, wherein the computer processor generates the second graphical user interface in response to replacing first words corresponding to the first language data displayed by the first graphical user interface with translated second words corresponding to the second language data.

8. The electronic device of claim 3, wherein the computer processor generates a control signal that controls the electronic device to generate an alert indicating a locale of the device has been changed.

9. An electronic device configured to operate according to a plurality of different locales, the electronic device comprising:
a display unit configured to display a first user interface including first language data;
at least one sensor configured to detect speech; and
an electronic computer processor in signal communication with the display unit and the at least one sensor, the computer processor configured to identify an input language of the speech, and based on the identified input language, convert the first language data into a second language matching the identified input language.

10. The electronic device of claim 9, wherein the computer processor identifies the input language based on a comparison between at least one input word extracted from the detected speech and a reference word stored in a language dictionary corresponding to a country locale.

11. The electronic device of claim 10, wherein the computer processor automatically transitions the second user interface back into the first user interface that displays the first language data after use of the second graphical user interface is completed.

12. The electronic device of claim 11, wherein the computer processor automatically initiates the first and second graphical user interfaces without input from a user of the device.

13. A computer program product to operate an electronic device according to a plurality of different locales, the computer program product comprising a computer readable storage medium having program instructions embodied therewith, the program instructions executable by an electronic computer processor such that the electronic device performs operations comprising:
displaying a first graphical user interface on a display of the electronic device;
detecting an input to the electronic device;
identifying an input language of the input; and
based on the identified input language, transitioning the electronic device from a first locale among the plurality of locales into a second locale among the plurality of locales different from the first locale so as to change the first graphical user interface into a different second graphical user interface.

14. The computer program product of claim 13, wherein the first locale includes first language data and the second locale includes second language data different from the first language data.

15. The computer program product of claim 14, wherein transitioning the electronic device from the first locale into the second locale further comprises converting a first graphical user interface generated according to the first language data into a second graphical user interface generated according to the second language data different from the first language data.

16. The computer program product of claim 15, wherein the operations further comprise automatically transitioning the second user interface back into the first user interface that displays the first language data after use of the second graphical user interface is completed without input from a user of the electronic device.

17. The computer program product of claim 15, wherein detecting the input includes detecting at least one of spoken language, an incoming text message, an incoming email, a captured image, and startup of a software application.

18. The computer program product of claim 15, wherein identifying the input language comprises:
extracting at least one word from the input;
comparing the at least one extracted word to a defined word included in at least one language dictionary stored in the electronic device; and
determining the input language corresponds to the first language dictionary in response to the extracted word matching the defined word.

19. The computer program product of claim 18, wherein the operations further comprise generating the second graphical user interface further comprises replacing first words corresponding to the first language data displayed by the first graphical user interface with translated second words corresponding to the second language data.

20. The computer program product of claim 15, wherein the operations further comprise generating a control signal that controls the electronic device to generate an alert indicating a locale of the electronic device has been changed.
